(19) United States
(12) Patent Application Publication
(10) Pub. No.: US 2008/0026814 A1
(43) Pub. Date: Jan. 31, 2008

(54) Gaming machine

(75) Inventor: Kazuo Okada, Tokyo (JP)

Correspondence Address: ARENT FOX LLP, 1050 CONNECTICUT AVENUE, N.W., SUITE 400, WASHINGTON, DC, 20036, US

(73) Assignee: ARUZE CORP.

(21) Appl. No.: 11/493,926

(22) Filed: Jul. 27, 2006

(51) Int. Cl. A63F 13/00

(52) U.S. Cl. 463/20

(57) ABSTRACT

It is possible to stabilize the profit of the game arcade by keeping the expectation value without compromising the amusement of the game. And further it is possible to provide a gaming machine that satisfies various tastes of a player. A plurality of symbols is displayed in a stationary manner after being displayed variably. If the stationary display of symbols includes a predetermined winning combination, a predetermined number of game media are paid out. In such a gaming machine, the expectation value for a specific winning combination in one game is the same, but the variation of the payout numbers for the specific winning combination differs in different modes such that one of the different modes can be selected in response to an operation by the player.

### CROSS REFERENCE TO RELATED APPLICATIONS

This application is related to a co-pending U.S. patent application entitled “Gaming Machine” and being filed on even date herewith and being assigned to the same assignee as the present application. The co-pending application including specification, drawings and claims is expressly incorporated herein by reference in its entirety.

### FIELD OF THE INVENTION

The present invention relates to a gaming machine such as a slot machine, a pachi-slot machine and a pachinko machine.

### RELATED ART

In the gaming machine such as a slot machine or a video slot machine, after a plurality of symbols is displayed variably, they come to a halt and are displayed in a stationary manner so as to match a predetermined wining combination of symbols such that the number of coins corresponding to the predetermined winning combination are paid out to a player or that the player can play a bonus game in which the player may be able to obtain many coins. In such a gaming machine, it is regulated that the number of coins to be paid out for insertion of one coin, i.e., a so-called expectation value must be within a predetermined range due to the predetermined rules. This is because the game loses attractiveness if the expectation value is too low while the player's passion for gambling may be aroused undesirably if the expectation value is too high, then the healthy gaming is ruined.

Therefore, as to setting of the expectation value, for example, there has been conventionally a gaming machine in which a bonus game is played without paying out coins if a specific winning combination is established (e.g., Japanese Unexamined Patent Application Publication No. H06-238035). Also, there has been a gaming machine in which a specific game is played wherein the specific game, which is different from the bonus game, has a higher expectation value than the base game (e.g., Japanese Unexamined Patent Application Publication Nos. 2002-315872 and 2002-315873). According to Japanese Unexamined Patent Application Publication Nos. H06-238035 and 2002-315873, there have been gaming machines in which variation of the number of payout coins may become bigger while the expectation value is kept constant.

### SUMMARY OF THE INVENTION

According to the present invention, it is possible to provide a gaming machine which can satisfy various kinds of tastes of the players. The gaming machine comprises: a display device for conducting a stationary display and a variable display of a plurality of symbols, in which a predetermined amount of game value is provided when a combination of the plurality of symbols being displayed in a stationary manner after being displayed variably matches a winning combination in one game. A plurality of modes having different natures of the one game, one of which can be selected by a player, is provided. Then, each of the plurality of modes differentiates both probability to win a specific winning combination and an amount of game value associated with the specific winning combination. And an expectation value of the amount of game value to be provided to the player is kept substantially identical for each of the plurality of modes in the one game.

Further features of the present invention, its nature, and various advantages will be more apparent from the accompanying drawings and the following description of the preferred embodiment.

### BRIEF DESCRIPTION OF THE DRAWINGS

FIG. 1 is a perspective view showing a general outer appearance of a slot machine according to a present embodiment.

FIG. 2 is a front view of a variable display part of the slot machine according to the present embodiment.

FIG. 3 is a front view showing an operation table of the slot machine according to the present embodiment.

FIGS. 4A through 4E show columns of symbols of the first reel bands through the fifth reel band to be displayed variably in the variable display part.

FIG. 5 is a block diagram schematically showing a control system of the slot machine according to the present embodiment.

FIG. 6 is a block diagram schematically showing a liquid crystal driving circuit of a liquid crystal display.

FIG. 7 shows each storage area in a ROM according to the present embodiment.

FIG. 8A is a drawing showing a probability table in Mode A.

FIG. 8B is a drawing showing a probability table in Mode B.

FIG. 8C is a drawing showing a probability table in Mode C.

FIG. 9A is a drawing showing a payout table in Mode A.

FIG. 9B is a drawing showing a payout table in Mode B.

FIG. 9C is a drawing showing a payout table in Mode C.

FIG. 10A is a drawing to illustrate expectation values in Mode A.

FIG. 10B is a drawing to illustrate expectation values in Mode B.

FIG. 10C is a drawing to illustrate expectation values in Mode C.

FIG. 11 is a flow chart showing a main process program of the slot machine according to the present embodiment.

FIG. 12 is a flow chart showing a mode selection process program of the slot machine according to the present embodiment.

FIG. 13 is a flow chart showing a start acceptance process program of the slot machine according to the present embodiment.

FIG. 14 is a flow chart showing a lottery process program of the slot machine according to the present embodiment.

FIG. 15 is a flow chart showing a base game process program of the slot machine according to the present embodiment.

FIG. 16 is a flow chart showing a bonus game process program of the slot machine according to the present embodiment.

FIG. 17 is a front view showing an image displayed on an upper liquid crystal display when Mode A is selected.

FIG. 18 is a front view showing an image displayed on an upper liquid crystal display when Mode B is selected.

FIG. 19 is a front view showing an image displayed on an upper liquid crystal display when Mode C is selected.

### DESCRIPTION OF THE PREFERRED EMBODIMENT

In the following, an explanation will be made in detail for a gaming machine according to the present invention based on a slot machine as an embodiment of the present invention in reference to the drawings. Here, in the present embodiment, an explanation will be made for a case where probability data are embodied in a table summarizing winning probabilities for each winning combination (hereafter, referred to as “probability table”) and payout data are embodied in a table summarizing payout numbers of game media for each winning combination (hereafter, referred to as “payout table”).

The slot machine according to the present embodiment is a slot machine utilizing a so-called video reel such that three modes of MODE A, MODE B and MODE C are provided and that the game is played in any one of MODES A through C as one mode is selected in response to an operation by a player. Also, if the game has not been played for a predetermined period of time, one mode that has been most frequently selected by the operation of the player is selected such that the game is started in the selected mode. If the winning probability and the payout number for the specific winning combination “LOBSTER×5” in MODE A are taken as the standard, MODE B is characterized by the low winning probability and the high payout number while MODE C is characterized by the high winning probability and the low payout number. A concrete explanation will be made later.

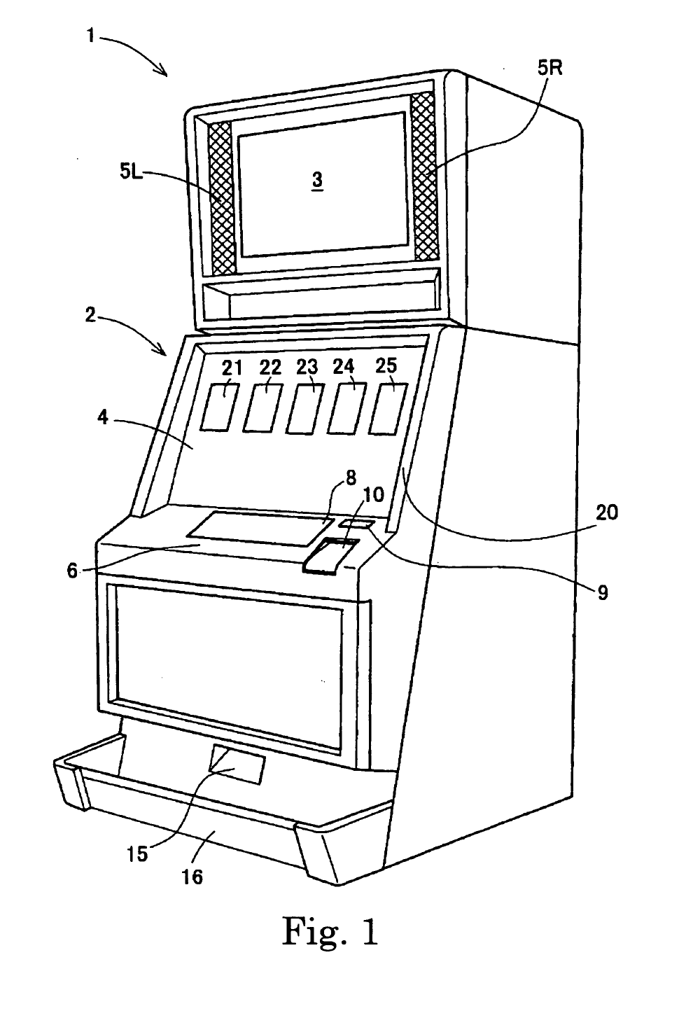

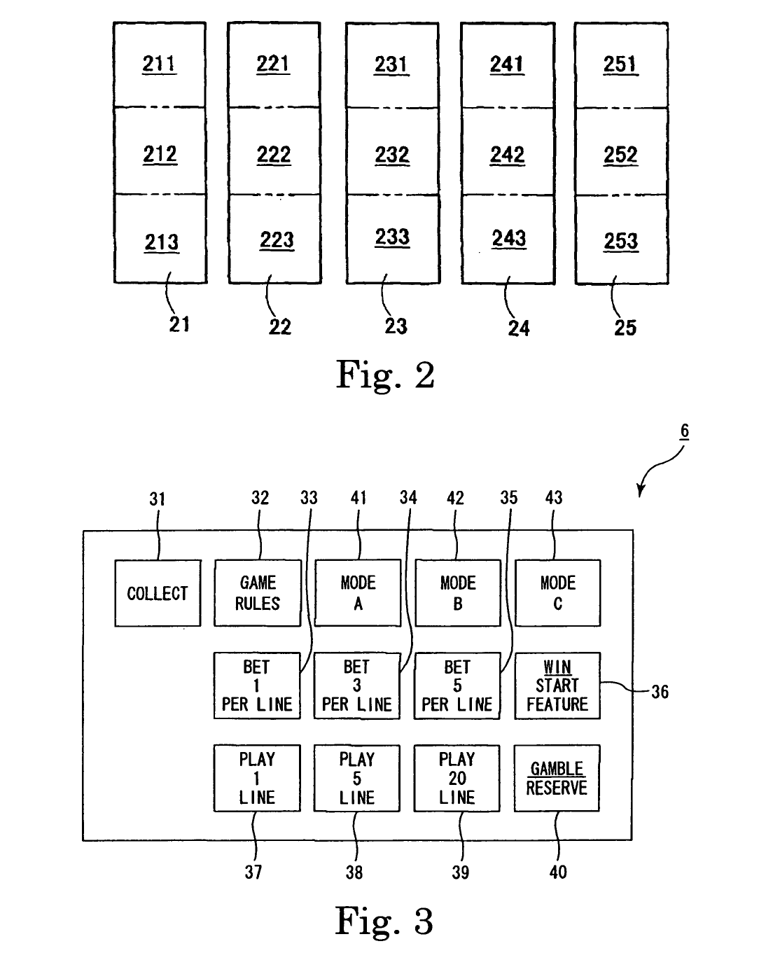

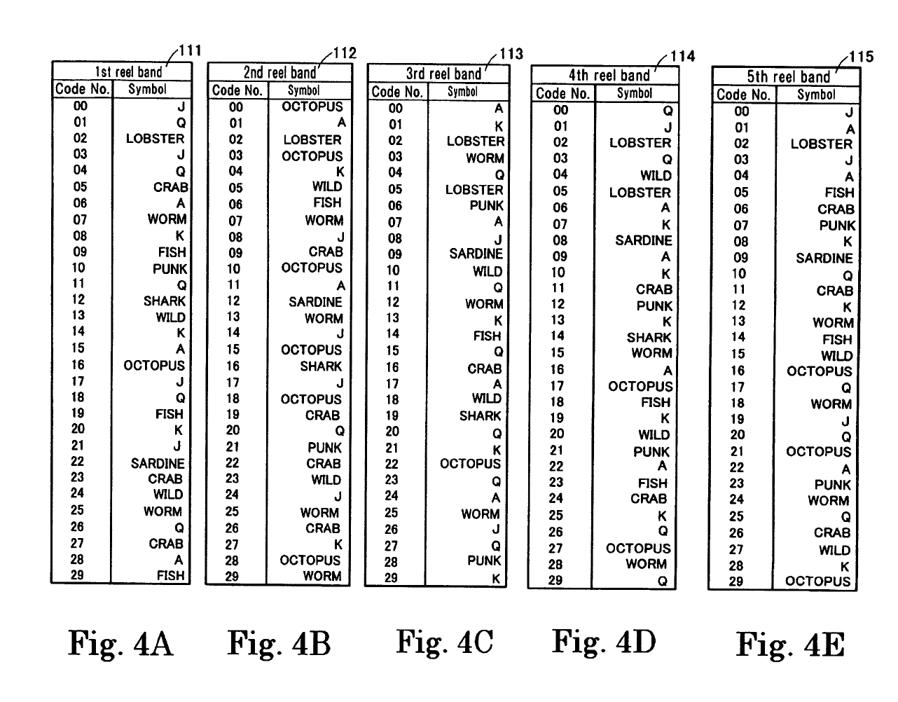

First, an explanation is made for a general configuration of the slot machine according to the present embodiment in reference to FIGS. 1 through 3. FIG. 1 is a perspective view showing a general outer appearance of the slot machine according to the present embodiment. FIG. 2 is a front view showing a variable display part of the slot machine according to the present embodiment. FIG. 3 is a front view showing an operation panel of the slot machine according to the present embodiment.

In FIG. 1, the slot machine 1 comprises a cabinet 2, which forms an entire shape thereof; and an upper liquid crystal display 3 being disposed on an upper front face of the cabinet 2, wherein a lower liquid crystal display 4 is disposed on an equipment front panel 20 being provided on a front center portion of the cabinet 2. Here, the upper liquid crystal display 3 and the lower crystal display 4 are composed of generally-and-commercially available liquid crystal displays.

Also, on the right and left sides of the upper liquid crystal display 3, a pair of speakers 5L, 5R are provided so as to output a predetermined BGM (background music), voice, effect sounds and so on to the player. Also, below the lower liquid crystal display 4, an operation table projecting frontward is provided. On the operation table 6, an operation panel 8 on which various buttons are disposed; a coin insertion part 9 through which game media such as coins are inserted; and a bill insertion part 10 through which a bill is inserted are provided from the left side.

On the lower liquid crystal display 3, information about the game is displayed such as a game method, a payout number of coins corresponding to a winning combination in the current mode, various kinds of effects about the game, and so on.

The upper liquid crystal display 3 works as display means for displaying the payout number. And the lower liquid crystal display 4 may also work as the display means for displaying the payout number.

On the lower liquid crystal display 4, a credit number the player currently owns and various kinds of effect images are displayed and five variable display parts 21, 22, 23, 24 and 25 are also displayed around the center. Then, various kinds of symbols to be described later are displayed variably as they are scrolled from top to bottom in each variable display part 21, 22, 23, 24, 25 and are stopped after a predetermined period of time elapses such that a predetermined combination of symbols appear.

Therefore, the slot machine 1 according to the present embodiment is a so-called video slot machine, in which a slot game (including two kinds of game aspects such as a base game and a bonus game) is played with video reels realized by displaying the symbols in respective variable display parts 21 through 25 of the lower liquid crystal display 4. Here, in the slot game (the base game and the bonus game) according to the present embodiment, three (3) symbols are stopped and displayed statically in each of the variable display parts 21 through 25 (fifteen (15) symbols in total).

More specifically, as shown in FIG. 2, the variable display parts 21 through 25 are divided into first stationary display areas 211, 221, 231, 241 and 251; second stationary display areas 212, 222, 232, 242 and 252; and third stationary display areas 213, 223, 233, 243 and 253 such that predetermined kinds of symbols are displayed statically (or in a stationary manner) in these respective stationary display areas 211 through 213, 221 through 223, 231 through 233, 241 through 243 and 251 through 253 based on a lottery result of an internal lottery to be described later.

Also, twenty pay lines being formed by connecting five (5) stationary display areas picked from these respective stationary display areas 211 through 213, 221 through 223, 231 through 233, 241 through 243 and 251 through 253 are provided . A payout is made when specific symbols are displayed statically in a specific combination along each pay line, which is activated, upon halt of symbols displayed variably. Now, each pay line is explained in the slot game (the base game and the bonus game).

The first pay line L1 is formed by connecting the second stationary display areas 212, 222, 232, 242, 252. The second pay line L2 is formed by connecting the first stationary display areas 211, 221, 231, 241, 251. The third pay line L3 is formed by connecting the third stationary display areas 213, 223, 233, 243, 253. In a similar manner, the fourth pay line L4 through the twentieth pay line L20 are formed by connecting five areas of the respective stationary display areas 211 through 213, 221 through 223, 231 through 233, 241 through 243 and 251 through 253.

Here, a pay line which is activated based on an operation of each BET button (BET 1 PER LINE button 33, BET 3 PER LINE button 34, and BET 5 PER LINE button 35) is referred to as “activated pay line” among the above twenty pay lines hereafter.

The lower liquid crystal display 4 works as variable display means. In the present invention, the variable display means is not limited to display means for conducting a variable display and a stationary display of the symbols electronically with images such as a liquid crystal display. For example, it may include display means for conducting the variable display and the stationary display mechanically with rotating reels.

Also, various kinds of operation buttons on the operation panel 8 are disposed on the operation table 6. Now, each operation button is concretely explained in reference to FIG. 3. A COLLECT button 31, a GAME-RULES button 32, a MODE-A button 41, a MODE-B button 42, and a MODE-C button 43 are provided from the leftmost side along the top row on the operation panel 8. A BET-1-PER-LINE button 33, a BET-3-PER-LINE button 34, a BET-5-PER-LINE button 35, and a WIN-START-FEATURE button 36 are provided from the leftmost side along the middle row. A PLAT-1-LINE button 37, a PLAT-5-LINES button 38, a PLAT-20-LINES button 39, and a GAMBLE-RESERVE button 40 are also provided from the leftmost side along the bottom row.

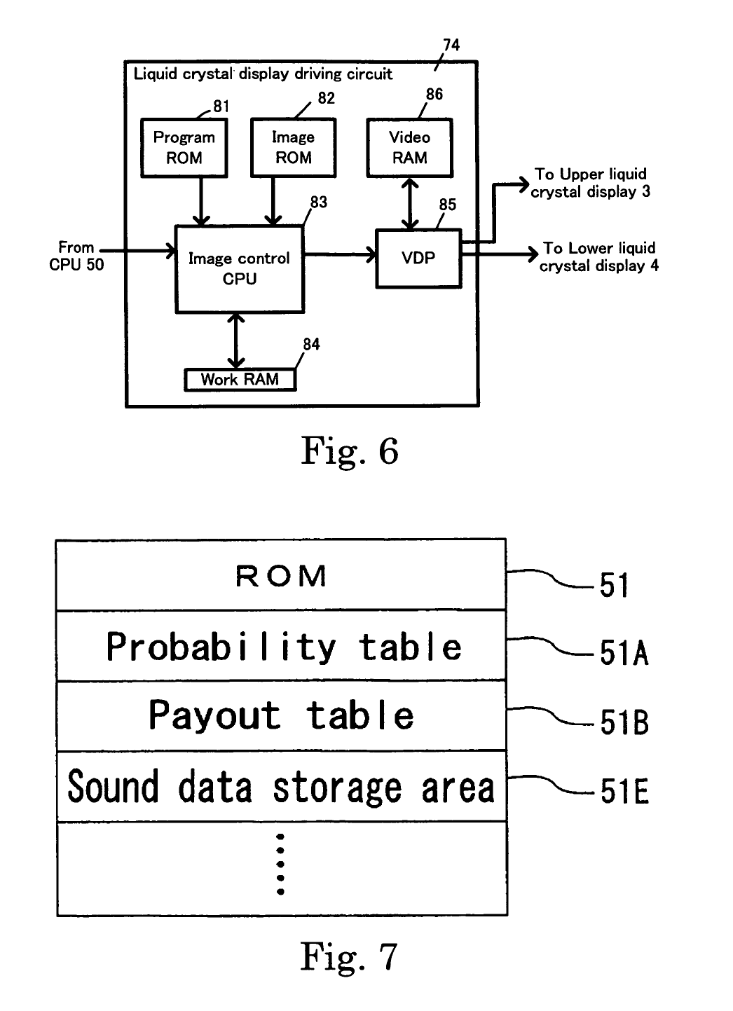

Here, the COLLECT button 31 is a button to be usually pressed at the end of the game such that the equivalent number of coins to the credit number having been earned during the game are paid out to a coin receiving part 16 from a coin payout opening 15 to be described later via a hopper (not shown) disposed inside the slot machine 1 once the COLLECT button 31 is pressed. Here, a COLLECT switch 45 is attached to the COLLECT button 31 so as to output a switch signal to a CPU 50 based on depression of the COLLECT button 31 (refer to FIG. 5).

The GAME RULES button 32 is a button to be pressed when the player is not sure of the game operation method and the like such that help information of various kinds is displayed on the upper liquid crystal display 3 and the lower liquid crystal display 4 once the GAME RULES button 32 is pressed. A GAME-RULES switch 46 is attached to the GAME RULES button 32 so as to output a switch signal from the GAME RULES switch 46 to the CPU 50 based on depression of the GAME RULES button 32.

A MODE-A button 41 is a button to select MODE A such that the MODE A is selected if the MODE A button 41 is pressed during a period of time when the game is not performed and that the game is played in the MODE A. Here, a MODE A switch 63 is attached to the MODE A button 41 so as to output a switch signal to the CPU 50 based on depression of the MODE A button 41 (refer to FIG. 5).

A MODE-B button 42 is a button to select MODE B such that the MODE B is selected if the MODE B button 42 is pressed during a period of time when the game is not performed and that the game is played in the MODE B. Here, a MODE B switch 64 is attached to the MODE B button 42 so as to output a switch signal to the CPU 50 based on depression of the MODE B button 42 (refer to FIG. 5).

A MODE-C button 43 is a button to select MODE C such that the MODE C is selected if the MODE C button 43 is pressed during a period of time when the game is not performed and that the game is played in the MODE C. Here, a MODE C switch 65 is attached to the MODE C button 43 so as to output a switch signal to the CPU 50 based on depression of the MODE C button 43 (refer to FIG. 5).

The BET-1-PER-LINE button 33 is a button to be pressed once to add one bet to each activated pay line from the credit the player currently owns. A 1-BET switch 57 is attached to the BET-1-PER-LINE button 33 such that, if the BET-1-PER-LINE button 33 is pressed, a switch signal is outputted from the 1-BET switch 57 to the CPU 50 based on depression thereof.

The BET-3-PER-LINE button 34 is a button to be pressed to start the game with three (3) BETS per each activated pay line based on depression thereof. A 3-BET switch 58 is attached to the BET-3-PER-LINE button 34 such that, if the BET-3-PER-LINE button 34 is pressed, a switch signal is outputted from the 3-BET switch 58 to the CPU 50 upon depression thereof (refer to FIG. 5).

The BET-5-PER-LINE button 35 is a button to be pressed to start the game with five (5) BETS per each activated pay line based on depression thereof. A 5-BET switch 59 is attached to the BET-5-PER-LINE button 35 so as to output a switch signal from the 5-BET switch 59 to the CPU 50 based on depression thereof (refer to FIG. 5).

Therefore, depression of the BET-1-PER-LINE button 33, the BET-3-PER-LINE button 34, or the BET-5-PER-LINE button 34 determines the BET number to be bet to each line of the activated pay lines.

Also, the WIN-START-FEATURE button 36 is a button to be pressed so as to start the bonus game to be described later and to add the payout amount having been obtained during the bonus game to the credit. A WIN-START switch 47 is attached to the WIN-START-FEATURE button 36 so as to output a switch signal from the WIN-START switch 47 to the CPU 50 upon depression thereof (refer to FIG. 5).

The PLAY-1-LINE button 37 is a button to be pressed to start the game with “one (1)” activated pay line based on depression thereof. A 1-LINE switch 60 is attached to the PLAY-1-LINE button 37 so as to output a switch signal from the 1-LINE switch 60 to the CPU 50 based on depression thereof (refer to FIG. 5).

The PLAY-5-LINES button 38 is a button to be pressed to start the game with “five (5)” activated pay lines based on depression thereof. A 5-LINES switch 61 is attached to the PLAY-5-LINES button 38 so as to output a switch signal from the 5-LINES switch 61 to the CPU 50 based on depression thereof (refer to FIG. 5).

The PLAY-20-LINES button 39 is a button to be pressed to start the game with “twenty (20)” activated pay lines based on depression thereof. A 20-LINES switch 62 is attached to the PLAY-20-LINES button 39 so as to output a switch signal from the 20-LINES switch 62 to the CPU 50 based on depression thereof (refer to FIG. 5).

Therefore, the number of the activated pay lines is determined by depression of the PLAY-1-LINE button 37, the PLAY-5-LINES button 38 and the PLAY-20-LINES button 39.

AT this point, if the PLAY-1-LINE button 37 is pressed, the first pay line L1 is activated. Also, if the PLAY-5-LINES button 38 is pressed, the first pay line L1 through the fifth pay line L5 are activated. Also, if the PLAY-20-LINES button 39 is pressed, the first pay line L1 through the twentieth pay line L20 are activated.

Also, the PLAY-1-LINE button 37, the PLAY-5-LINES button 38 and the PLAY-20-LINES button 39 work as start buttons to start the variable display of symbols in the variable display parts 21 through 25 of the lower liquid crystal display 4 so as to start the game with the current bet number and the corresponding number of activated pay lines upon depression thereof.

The GAMBLE-RESERVE button 40 is a button to be pressed when the player leaves the seat or when the player wishes to shift the game to the double down game after the bonus game. Here, the double down game is a game to be played by utilizing the credit having been obtained in the bonus game, but the detailed explanation is omitted.

A GAMBLE-RESERVE switch 48 is attached to the GAMBLE-RESERVE button 40 so as to output a switch signal from the GAMBLE-RESERVE switch 48 to the CPU 50 based on depression thereof (refer to FIG. 5).

A coin sensor 49 is disposed in the coin insertion part 9 such that a coin detection signal is outputted to the CPU 50 via the coin sensor 49 (refer to FIG. 5) and a credit corresponding to the number of coins having been inserted is added. Also, a bill sensor 67 is disposed in the bill insertion part 10 such that a bill detection signal is outputted to the CPU 50 via the bill sensor 67 (refer to FIG. 5) and a credit corresponding to the amount of the bill having been inserted is added.

Also, the coin payout opening 15 is formed and the coin receiving part 16 to receive coins being paid out from the coin payout opening 15 is provided at lower part of the cabinet 2. Inside of the coin payout opening 15, a hopper 71 which can discharge coins one by one and a coin detector 73 being composed of a sensor and the like to be described later are disposed (refer to FIG. 5) such that the coin detector 73 detects the number of coins being discharged from the coin payout opening 15. Also, it is OK to configure the slot machine so as to discharge a receipt-like piece of paper on which the number of coins (value) to be paid out instead of paying out the coins directly. In such an occasion, the player brings the discharged receipt (the piece of paper) to the counter of the game arcade so as to replace the receipt with the actual prizes.

Here, one game may include a series of actions of the bet operation based on the currently-owned credit, the variable display and stationary display of the symbols and various kinds of processes (e.g., bonus game process and payout process) in accordance with the combination of symbols displayed in a stationary manner.

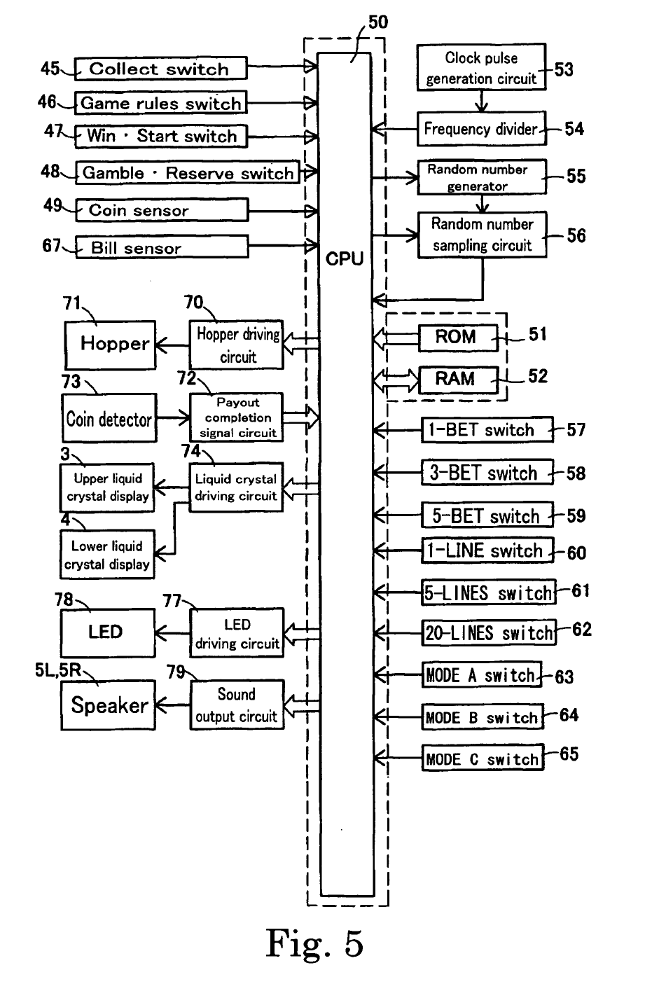

Further, in reference to FIGS. 4A through 4E, examples of the variably-displayed symbols as being scrolled in each variable display part 21 through 25 of the lower liquid crystal display 4 are explained. In FIG. 4A, an array of symbols shown in a first reel band 111 is an array of symbols which are variably displayed in the variable display part 21. In FIG. 4B, an array of symbols shown in a second reel band 112 is an array of symbols which are variably displayed in the variable display part 22. In FIG. 4C, an array of symbols shown in a third reel band 113 is an array of symbols which are variably displayed in the variable display part 23. In FIG. 4D, an array of symbols shown in a fourth reel band 114 is an array of symbols which are variably displayed in the variable display part 24. In FIG. 4E, an array of symbols shown in a fifth reel band 115 is an array of symbols which are variably displayed in the variable display part 25.

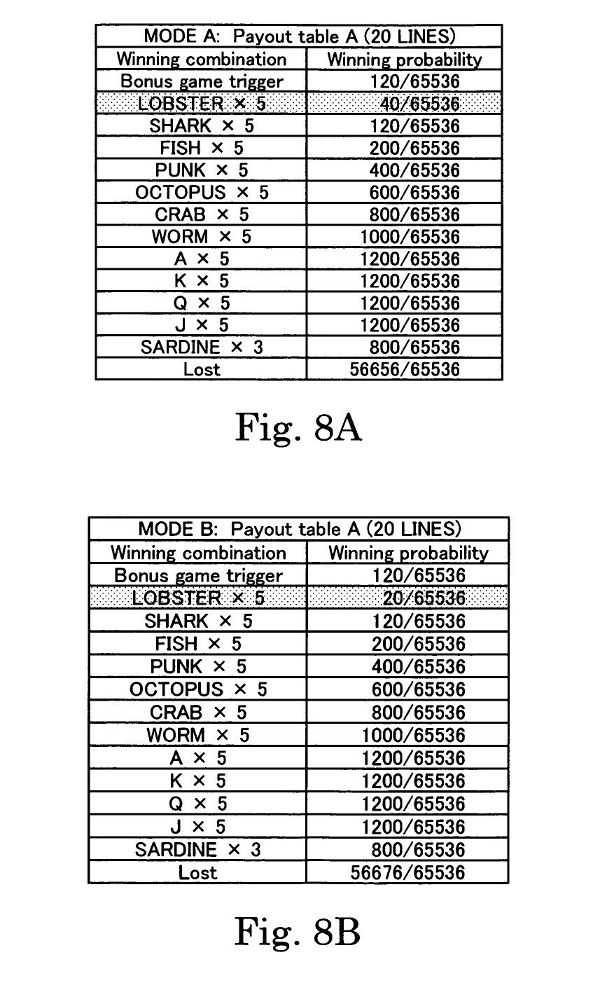

Here, dot data to form images indicated in the arrays of symbols of the first reel band 111 through the fifth reel band 115 are stored in an image ROM 82 (refer to FIG. 6).

Here, the arrays of symbols shown in the first reel band 111 through the fifth reel band 115 are different each other and the arrays of symbols are composed of thirteen kinds of symbols: “SHARK”, “FISH”, “PUNK”, “OCTOPUS”, “CRAB”, “WORM” and “SARDINE”, but arranged in different manners, respectively.

Here, “LOBSTER” indicates an image of a lobster. Also, “SHARK”, “FISH”, “PUNK”, “OCTOPUS”, “CRAB”, “WORM” and “SARDINE” indicate images of a shark, fish, a person with a guitar, an octopus, a worm and a sardine, respectively. Further, “A”, “K”, “Q”, “J” and “WILD” indicate alphabet images of alphabetic characters thereof, respectively.

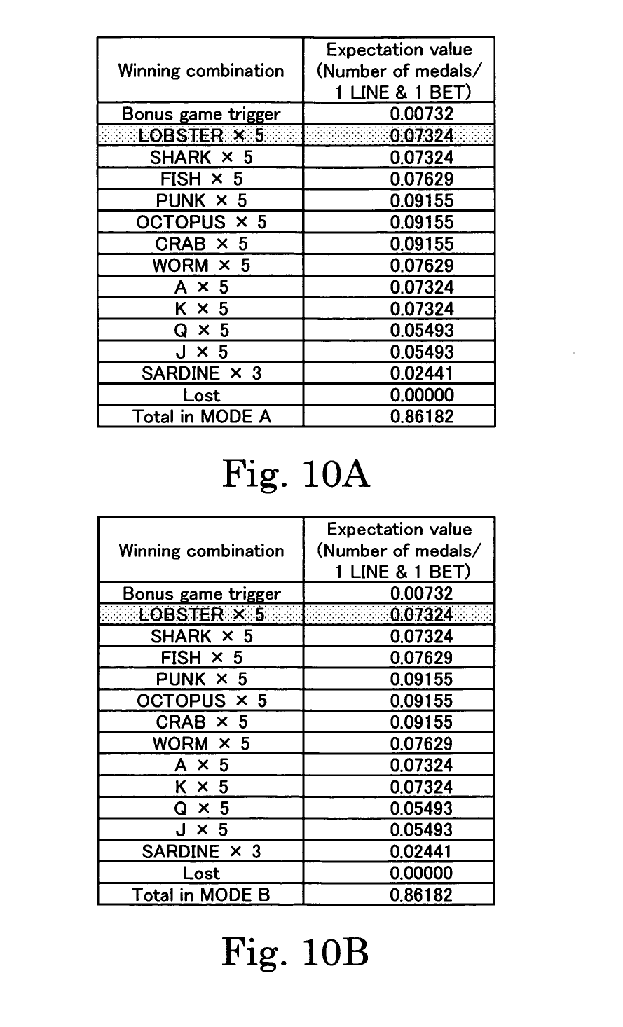

And if a predetermined number of “LOBSTER”, “SHARK”, “FISH”, “PUNK”, “OCTOPUS”, “CRAB”, “WORM”, “A”, “K”, “Q” and “J” are displayed consecutively in a stationary manner along any of the first to the twentieth pay lines L1 to L20 from the left side, a predetermined credit number is added to the credit the player owns (refer to FIGS. 9A through 9C).

Here, “SARDINE” is a so-called scattered symbol such that a predetermined credit number is added to the credit the player owns if more than a predetermined number of “SARDINE” symbols (for example, “three” in the first embodiment) are displayed in the variable display parts 21 through 25 irrespective of the activated pay lines (refer to FIGS. 9A through 9C). Further, as described later, “SARDINE” is also a bonus game shift symbol to let the game shift into the bonus game such that the game may shift into the bonus game if a predetermined number of “SARDINE” symbols (for example, “five” in the present embodiment) are displayed in a stationary manner in the variable display parts 21 to 25 irrespective of the activated pay lines. Also, “WILD” is a so-called wild symbol, which can be regarded as any kind of symbol other than “SARDINE” (scatter symbol).

And the arrays of symbols indicated by the first reel 111 through the fifth reel are displayed as being scrolled from top to bottom in each variable display part 21 to 25 when one of the PLAY-1-LINE button 37, the PLAY-5-LINES button 38 and the PLAY-20-LINES button 39 is depressed to start the game. After a predetermined period of time, three symbols are stopped and displayed in each variable display part.

Further, various kinds of winning combinations of symbols described above are set beforehand (refer to FIGS. 9A through 9C) and the payout for each winning combination is added to the credit if the combination of symbols corresponding to any of the winning combinations come to a halt and are displayed along any of the activated pay lines. Further, if the predetermined number of “SARDINE” symbols are stopped and displayed at the same time irrespective of the activated pay lines, the game shifts to the bonus game.

Next, the configuration of the control system of the slot machine 1 is explained in reference to FIG. 5. FIG. 5 is a block diagram showing schematically the control system of the slot machine 1.

In FIG. 5, the control system of the slot machine 1 is basically composed of the CPU 50 as a kernel thereof and the CPU 50 is connected to ROM 51 and RAM 52.

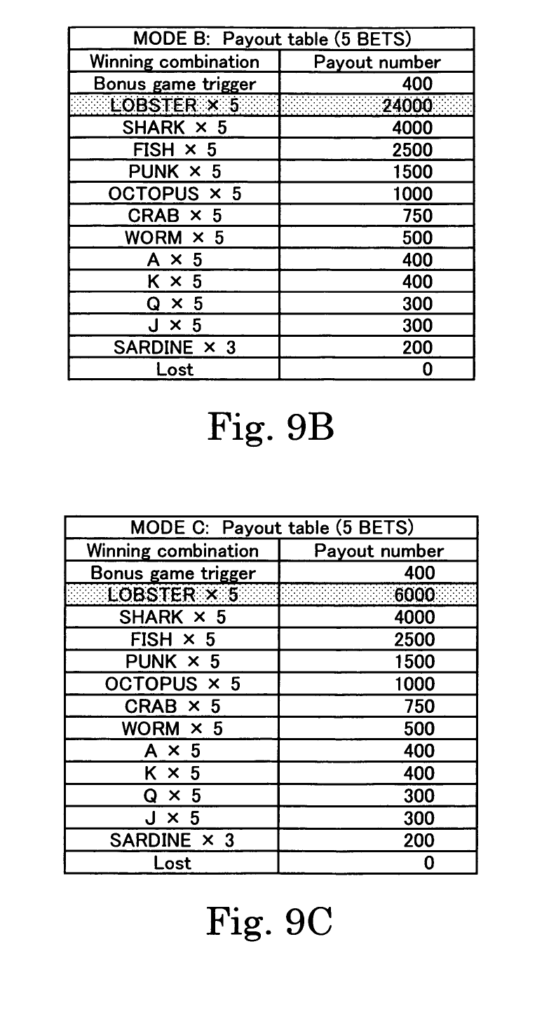

The ROM 51 stores a main process program to be described later, a mode selection process program, a base game process program, a bonus game process program, a plurality of probability tables listing the winning probabilities for each winning combination (refer to FIGS. 8A through 8C), a plurality of payout tables listing the number of payout coins for each winning combination (refer to FIGS. 9A through 9C), voice data of each character to be outputted from the speakers during the effect display, and other various kinds of programs, data tables, etc. necessary for controlling the slot machine 1.

The plurality of kinds of probability tables is prepared for the modes A through C, respectively. Also, different probability tables for respective numbers of pay lines are stored as the probability table corresponding to each of the modes A through C. And if the probability tables are referred to, an exact probability table corresponding to the current mode and the current number of pay lines is referred to. The ROM 51 works as probability table storage means for storing probability tables listing winning probabilities for each winning combination in association with the respective plurality of kinds of modes (game kind).

The plurality of kinds of payout tables is prepared for the modes A through C, respectively.

And the number of payout coins is determined by referring to the payout table corresponding to the kind of mode at the point so that the number of actually-paid coins is given by multiplying a resultant payout number thereof by the bet number. The ROM 51 works as payout table storage means for storing payout tables to determine the payout number of coins to be paid out for each winning combination for the plurality of kinds of modes (game kinds), respectively.

Also, the RAM 52 is a memory for storing temporarily various kinds of data calculated by the CPU 50. Also, the RAM 52 stores the number of games having been played in thus-selected modes (game kinds) as history information in association with the modes A though C, respectively. The RAM 52 works as history information storage means.

Also, the CPU 50 is connected to a clock pulse generating circuit 53 and a frequency divider 54, and further it is connected to a random number generator 55 and a random number sampling circuit 56. The random number sampled by the random number sampling circuit 56 is utilized for various kinds of lotteries to select the winning combination or the like. Further, the CPU 50 is connected to the COLLECT switch 45 attached to the COLLECT button 31, the GAME-RULES switch 46 attached to the GAME-RULES button 32, 1-BET switch 57 attached to the BET-1-PER-LINE button 33, 3-BET switch 58 attached to the BET-3-PER-LINE button 34, 5-BET switch 59 attached to the BET-5-PER-LINE button 35, WIN-START switch 47 attached to the WIN-START-FEATURE button 36, 1-LINE switch 60 attached to the PLAY-1-LINE button 37, 5-LINES switch 61 attached to the PLAY-5-LINE button 38, 20-LINES switch 62 attached to the PLAY-20-LINE button 39, the GAMBLE-RESERVE switch 48 attached to the GAMBLE-RESERVE button 40, the MODE A switch 63 attached to the MODE A button 41, the MODE B switch 64 attached to the MODE B button 42 and the MODE C switch 65 attached to the MODE C button 43, respectively. The CPU 50 conducts a control to carry out each kind of operation corresponding to each button based on the switch signal transmitted from each switch upon depression of each button.

Further, the CPU 50 is connected to the coin sensor 49 arranged in the coin insertion part 9 and the bill sensor 67 arranged in the bill insertion part 10. The coin sensor 49 detects coins inserted through the coin insertion part 9 and the CPU 50 calculates the number of the inserted coins based on the coin detection signal transmitted from the coin sensor 49. The bill sensor 67 detects the kind and the amount of the bill inserted through the bill insertion part 10 and the CPU 50 calculates the credit number equivalent to the amount of the bill based on the bill detection signal transmitted from the bill sensor 67.

The CPU 50 is connected to the hopper 71 through a hopper driving circuit 70. When a driving signal is transmitted from the CPU 50 to hopper driving circuit 70, the hopper 71 pays out the predetermined number of coins through the coin payout opening 15.

Further, the CPU 50 is connected to the coin detector 73 via the payout completion signal circuit 72. The coin detector 73 is disposed inside the coin payout opening 15 and if the coin detector 73 detects the predetermined number of coins are paid out, a coin payout detection signal is transmitted from the coin detector 73 to the payout completion signal circuit 72 such that the payout completion signal circuit 72 outputs the payout completion signal to the CPU 50. Further, the CPU 50 is connected to the upper liquid crystal display 3 and the lower liquid crystal display 4 via the liquid crystal driving circuit 74 such that the CPU 50 controls the upper liquid crystal display 3 and the lower liquid crystal display 4.

In this point, the liquid crystal driving circuit 74 is configured with a program ROM 81, an image ROM 82, an image control CPU 83, a work RAM 84, VDP (video-display-processor) 85, a video RAM 86 and so on. And the program ROM 81 stores an image control program and various kinds of selection tables relating to the display on the upper liquid crystal display 3 and the lower liquid crystal display 4. Also, the image ROM 82 stores dot data for forming images such as payout display images displayed on the upper liquid crystal display 3 and the first reel band 111 through the fifth reel band 115 as shown in FIGS. 4A through 4E to be displayed on the lower liquid crystal display 4.

The image control CPU 83 determines images to be displayed on the upper liquid crystal display 3 and the lower liquid crystal display 4 among the dot data having been stored beforehand in the program ROM 81 based on a parameter set by the CPU 50. Also, the work RAM 84 is configured as a temporal storage means when the image control program is executed by the image control CPU 83. Also, the VDP 85 forms an image corresponding to the display content having been determined by the image control CPU 83 and outputs such an image to the upper liquid crystal display 3 and the lower liquid crystal display 4. Thus, the arrays of symbols indicated by the reel bands 111 through 115 are scrolled and displayed on the lower liquid crystal display 4 (or in the variable display parts 21 through 25), for example. Here, the video RAM 86 is configured as temporal storage means to form an image with the VDP 85.

Also, the CPU 50 is connected to a LED 78 via a LED driving circuit 77. The LED 78 is controlled by the LED driving circuit 77 to blink based on a driving signal transmitted from the CPU 50 as various kinds of effects are performed on the front face of the slot machine on which many LED elements are provided. In particular, in the slot machine 1 of the present embodiment, the LED 78 is lit to enhance the effects during the bonus game to be described later.

Also, the CPU 50 is connected to a sound output circuit 79 and speakers 5L, 5R such that the speakers 5L, 5R generate voices and effect sounds when various effects are performed in accordance with an output signal from the sound output circuit 79.

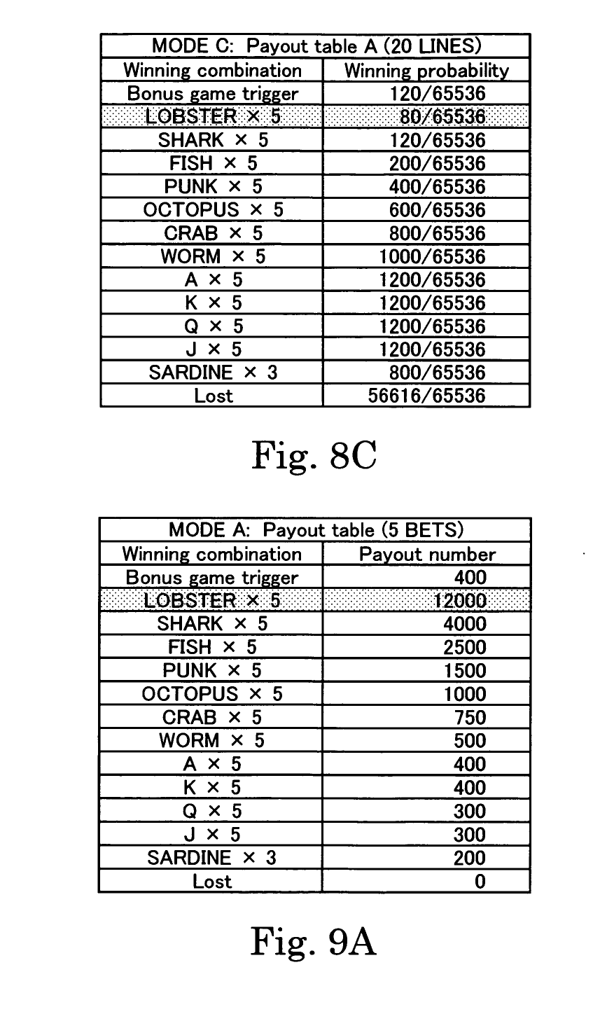

Also, as shown in FIG. 7, the ROM 51 stores a probability table 51A, a payout table 51B and a sound data storage area 51E storing voice data to be outputted from the speakers 5L, 5R during the effect performance.

FIGS. 8A through 8C illustrate probability tables in the case of twenty (20) pay lines. FIG. 8A shows a drawing of the probability table of MODE A, FIG. 8B shows a drawing of the probability table of MODE B, and FIG. 8C shows a drawing of the probability table of MODE C.

As shown in FIGS. 8A through 8C, the random number values to be utilized in the probability tables are sixty five thousand five hundred thirty six (65,536) numeric values ranged from 0 to 65,536 and each numeric value corresponds to each winning combination. Here, the winning combinations may include so-called losing combinations with which the player lose the game. In the drawings, each winning probability is indicated for each winning combination.

If the winning combination is determined by the probability table in MODE A as shown in FIG. 8A, the way of determining the winning combination is explained as follows.

The trigger for the bonus game is won with the probability of 120/65536. In this case, if five “SARDINE” symbols are displayed in a stationary manner at the same time irrespective the pay lines, the combination of symbols is a winning combination such that the program proceeds to the bonus game.

The winning combination of “LOBSTER” is won with the probability of 40/65536. In this case, five “LOBSTER” symbols are displayed in a stationary manner along the activated pay line to form a winning combination.

The winning combination of “SHARK” is won with the probability of 120/65536. In this case, five “SHARK” symbols (shark) are displayed in a stationary manner along the activated pay line to form a winning combination.

In a similar way, “FISH” with the probability of 200/65536, “PUNK” with the probability of 600/65536, “OCTOPUS” with the probability of 600/65536, “CRAB” with the probability of 800/65536, “WORM” with the probability of 1000/65536, “A” with the probability of 1200/65536, “K” with the probability of 1200/65536, “Q” with the probability of 1200/65536, and “J” with the probability of 1200/65536 are won as the winning combination such that five symbols of a kind corresponding to each kind of winning combination are displayed in a stationary manner. The “SARDINE” winning combination is won with the probability of 800/65536 such that three “SARDINE” symbols (sardine) are displayed in a stationary manner irrespective to the activated pay lines.

On the other hand, a losing combination is won with the probability of 56656/65536 (i.e., the game is lost) such that a losing combination of symbols other than the above-mentioned winning combinations are displayed in a stationary manner.

FIG. 8B shows the probability table in MODE B.

In the probability table, each winning probability is defined for each winning combination and the winning probability for the “LOBSTER” winning combination is one-half of that defined in the probability table in MODE A (refer to FIG. 8A).

FIG. 8C shows the probability table in MODE C.

In the probability table, each winning probability is defined for each winning combination and the winning probability for the “LOBSTER” winning combination is twice as high as that defined in the probability table in MODE A (refer to FIG. 8A).

In the slot machine 1, after the lottery to determine the winning combination, a lottery to determine a stationary display combination of symbols (a lottery to determine a code number) is conducted so as to display the winning combination of symbols is displayed in a stationary manner. And the symbols are displayed in a stationary manner according to the lottery result. Here, FIGS. 8A through 8C show the probability tables in the case of 20 LINES, each winning combination other than “Lost” is in proportion to the number of the activated pay lines in the slot machine 1. For example, in the probability table in the case of 1 LINE, the probabilities to win the winning combinations other than “Lost” are set to one-twentieth (1/20) of those in the probability table in the case of 20 LINES.

Next, the winning combination and a payout thereof are explained in reference to FIGS. 9A through 9C when the base game and the bonus game are conducted by utilizing the five variable display parts 21 through 25 in the slot machine 1.

FIG. 9A shows a payout table in MODE A, FIG. 9B shows a payout table in MODE B, and FIG. 9C shows a payout table in MODE C.

Here, the payout tables shown in FIGS. 9A through 9C indicate payout values when “5” is set as the bet number. Therefore, if the bet number is “5”, the payout values shown in FIGS. 9A through 9C are added to the credit. However, if the bet number is other than “5”, that is, the bet number is “N” (N is a natural number less than 5), the payout values shown in FIGS. 8A to 8D are multiplied by N/S and the resultant values are added to the credit.

As shown in FIG. 9A, the payout number of “400” is associated with the bonus game trigger in the payout table in MODE A. The payout number of “12000” is also associated with “LOBSTER×5”. The payout number of “4000” is also associated with “SHARK×5”. The payout number of “2500” is also associated with “FISH×5”. The payout number of “1500” is also associated with “PUNK×5”. The payout number of “1000” is also associated with “OCTOPUS×5”. The payout number of “750” is also associated with “CRAB×5”. The payout number of “500” is also associated with “WORM×5”. The payout number of “400” is also associated with “A×5”. The payout number of “400” is also associated with “K×5”. The payout number of “300” is also associated with “Q×5”. The payout number of “300” is also associated with “J×5”. The payout number of “200” is also associated with “SARDINE×3”.

Also, as shown in FIG. 9B, each payout number for each winning combination is defined in the payout table in MODE B and the payout number for the winning combination of “LOBSTER×5” is twice as many as that defined in the payout table in MODE A (refer to FIG. 9A).

Also, as shown in FIG. 9C, each payout number for each winning combination is defined in the payout table in MODE C and the payout number for the winning combination of “LOBSTER×5” is one-half of that defined in the payout table in MODE A (refer to FIG. 9A).

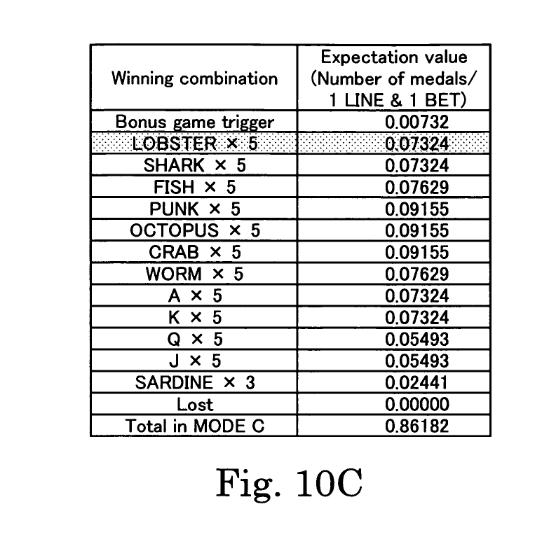

FIG. 10A illustrates expectation values in MODE A, FIG. 10B illustrates expectation values in MODE B, and FIG. 10C illustrates expectation values in MODE C.

The expectation value is calculated by the following formula (1).

Expectation value=(payout number/insertion number)×winning probability (1)

Insertion number=line number×bet number

According to FIGS. 10A through 10C, any of the expectation values for the “LOBSTER×5” are 0.007324 in MODE A through MODE C.

As explained above in reference to FIGS. 8A through 10C, the expectation values of the payout number for the winning combination of “LOBSTER×5” are the same in MODE A through MODE C, but the variations (variance) of payout numbers differ in MODE A through MODE C. That is to say, the expectation values in MODE B are the same as those in MODE A, but the winning probabilities are lower and the payout numbers are higher if compared to those in MODE A. And the expectation values in MODE C are the same as those in MODE A, but the winning probabilities are higher and the payout numbers are lower if compared to those in MODE A.

In the present embodiment, the winning combination of “LOBSTER×5” corresponds to a specific winning combination. And, in the present embodiment, an average value of the coin payout numbers defined in MODE A through MODE C for the winning combination of “LOBSTER×5” is 14000 such that the average value of 14000 is higher than any other payout number of coins for any other winning combination than “LOBSTER×5”. Here, in the present embodiment, an explanation is made for the case where the winning combination displayed in the variable display parts 21 through 25 is determined with one lottery by referring to FIGS. 8A through 8C. However, the present invention is not limited to this embodiment. For example, a lottery may be made for each of the variable display parts 21 through 25.

Next, the bonus game is explained. If five bonus trigger symbols appear (are displayed in a stationary manner) at the same time in the variable display parts 21 through 25 irrespective of the activated pay lines in this slot machine 1, the program may proceed to the bonus game.

Here, the bonus game is the game in the bonus game mode to be started if a specific condition is satisfied during the game in the base game mode and generally tends to be beneficial to the player. If the program proceeds to the bonus game in this instance, fifteen (15) to twenty five (25) games may be played consecutively and automatically without betting any credits or the like (so-called free game).

Here, the bet number and the number of the activated pay lines at the point of shifting to the bonus game are used in the bonus game. Also, the winning combinations and payouts thereof are the same as those of the game in the base game mode described above. However, “SHARK” symbol (shark) is handled as “LOBSTER” symbol (lobster) and if five “SARDINE” symbols in total appear (are displayed in a stationary manner), it is possible to shift to the bonus game again. Here, as shown in FIGS. 9A through 9C, the “LOBSTER” symbol (lobster) is associated with a higher number of payouts than that of the “SHARK” symbol (shark) in the case of winning such that it is likely for the player to obtain a large number of credits or the like without consuming the owned credits.

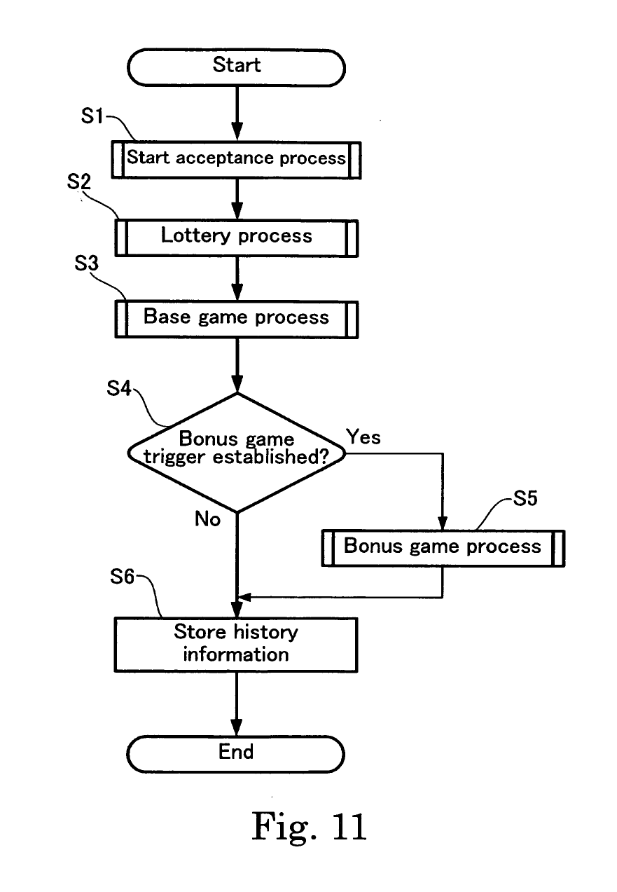

Next, the main process program of the slot machine 1 according to the present embodiment being configured as described above is explained in reference to FIG. 11. FIG. 11 shows a flow chart of the main process program of the slot machine according to the present embodiment. Here, each program shown by flow charts in FIGS. 11 through 16 is stored in the ROM 51 and/or the RAM 52 provided to the slot machine 1 and executed by the CPU 50.

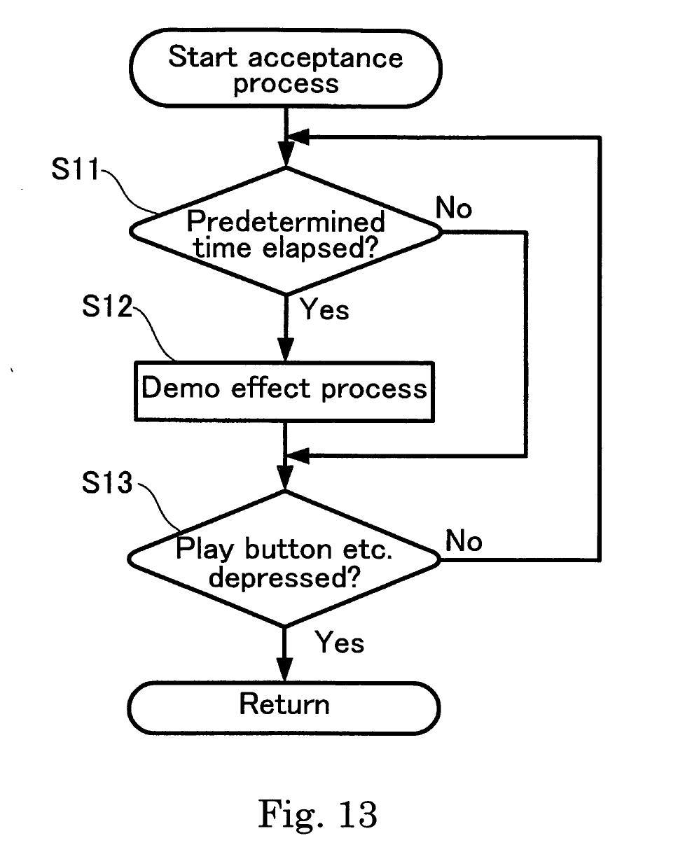

In FIG. 11, firstly in the step (abbreviated as “S” here after) 1, a start acceptance process in FIG. 13 to be described later is conducted. This process is a process to receive switch signals outputted from 1-BET switch 57, 3-BET switch 58, 5-BET switch 59, 1-LINE switch 60, 5-LINES switch 61, and 20-LINES switch 62 based on operations of the BET-1-PER button 33, the BET-3-PER-LINE button 34, the BET-5-PER-LINE button 35, the PLAY-1-LINE button 37, the PLAY-5-LINE button 38, and the PLAY-20-LINE button 39, respectively. The game is started when the switch signals outputted from the respective switches.

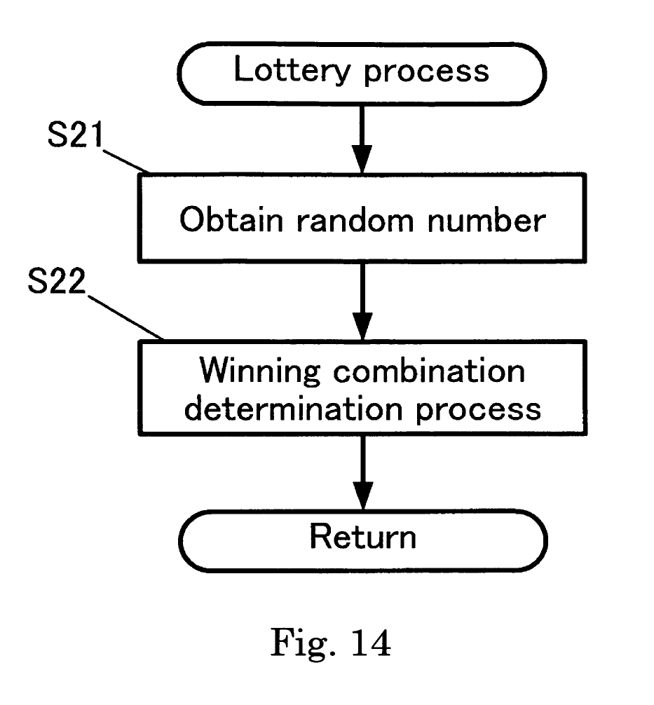

Then, in S2, a lottery process in FIG. 14 to be described later is conducted based on the switch signals outputted from the 1-LINE switch 60, the 5-LINES switch 61, and 20-LINES switch 62.

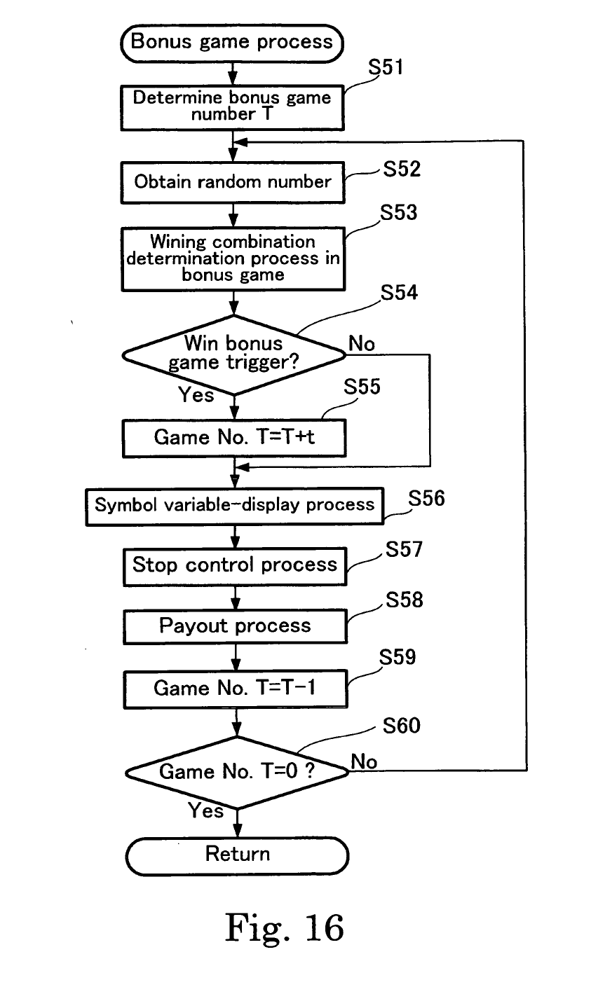

Here, if the bonus game is won (five “SARDINE” symbols (sardine) in total are displayed in a stationary manner in the variable display parts 21 through 25 irrespective of the activated pay lines), the bonus game to be described later will be conducted after the base game ends (refer to FIG. 16).

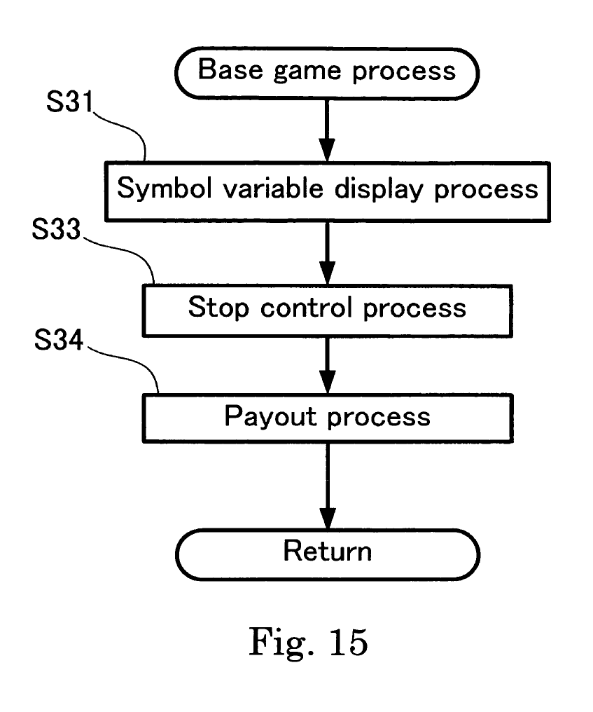

In S3, the base game process in FIG. 15 to be described later is conducted. Thereafter, the program proceeds to S4 to determine whether the bonus game has been won or not. More specifically, in the lottery process of S2, if five “SARDINE” symbols in total are displayed in a stationary manner irrespective of the activated pay lines, the bonus game is won (S4: YES) and the program proceeds to S5 to conduct a bonus game process in FIG. 16 to be described later. Then, the program proceeds to a process to store history information (S6) to be described later. On the other hand, in the lottery process of S2, if five “SARDINE” symbols in total are not displayed in a stationary manner irrespective of the activated pay lines, the bonus game is not won (S4: NO) and the program proceeds to the process to store history information (S6). In the process, the CPU 50 adds one to the game number in the current mode and renews the history information in the RAM 43. For example, if the game is conducted in MODE A, the history information is renewed such that one is added to the game number corresponding to MODE A. The RAM 43 may work as the history information storage means. Then, the main process program ends.

Next, the mode selection process routine is explained.

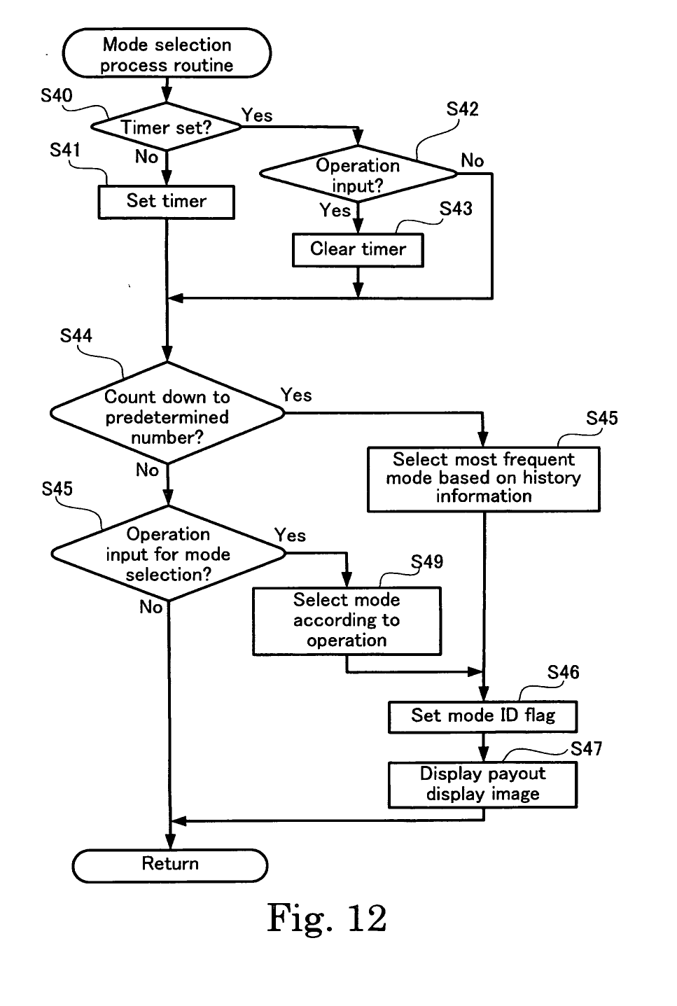

FIG. 12 shows a routine of a mode selection process program.

Here, the process is an interrupt process to be carried out at a predetermined timing by calling during a period of time when the game is not played, that is, when the process shown in FIG. 11 is not conducted.

First, the CPU 50 determines whether the timer is set in the RAM 52 or not (S40). This timer measures an elapsing time from the last operation such that the timer is set in the RAM 52 and the timer count is renewed periodically with a predetermined cycle.

In S40, if the CPU 50 determines that the timer is not set, the CPU 50 set the timer in the RAM 52 (S41). Then, an interrupt process is made with a predetermined cycle such that the timer count is renewed in the interrupt process.

On the other hand, in S40, if the CPU 50 determines that the timer is set, the CPU 50 determines whether an operation input is made or not (S42). The operation input in S42 is a signal input from any one of the switches 45 through 48 and 57 through 65, and the sensors 49, 67 such that it is determined that the operation input is made if the signal is received from any one of them. In S42, if it is determined that the operation input is made, the CPU 52 clears the timer set in the RAM 52 (S43).

If the process in S41 or S43 is carried out, or if it is determined that the operation input is not made in S42, the CPU 50 determines whether the value of the timer (timer value) set in the RAM 52 is a predetermined number or not (S44).

If it is determined that the timer value is the predetermined number, the CPU 50 selects the most frequently selected mode based on the history information stored in the RAM 52 (S45). The history information is information that shows the numbers of the games in the respective modes having been carried out and is stored in the RAM 52. Here, the CPU 50 works as selection means so as to select the mode from MODE A through MODE C that has been selected most frequently in response to the operation by the player based on the history information stored in the RAM 52 (history information storage means).

Next, the CPU 50 set a mode identification flag (S46). The mode identification flag is a flag to show which mode is selected among the MODE A through MODE C. Then, the liquid crystal driving circuit 74 is driven so as to display a payout display image showing the relationship between the winning combination and the payout number in the selected mode on the upper liquid crystal display 3 (S47). Then, the present routine ends.

On the other hand, in S44, if it is determined that the timer value does not match the predetermined value, the CPU 50 determines whether the mode is selected or not based on an operation of any one of the MODE A switch 63, the MODE B switch 64 and the MODE C switch 65 (S48). In S48, if it is determined that the operation for selecting the mode has not made, the present routine ends.

If it is determined that the operation for selecting the mode is conducted in S48, the CPU 50 selects one of the MODE A through MODE C in response to the operation. Here, the CPU 50 works as selection means so as to select one game kind from the game kinds A through C based on the operation by the player.

Next, the CPU 50 sets the mode identification flag (S46) and drives the liquid crystal driving circuit 74 so as to display the payout display image indicating the relationship between the winning combination and the payout number in the selected mode on the upper liquid crystal display 3. Then, the present routine ends.

Subsequently, in the slot machine 1 of the present embodiment, an explanation is made for a start acceptance process being conducted in S1 in reference to FIG. 13.

FIG. 13 is a flow chart of the start acceptance process program in the slot machine of the present invention.

In the start acceptance process, the CPU 50 first determines whether a predetermined period of time (e.g., 15 second) has elapsed or not in S11. In this process, if it is determined that the predetermined period of time has not elapsed (S11: NO), the program proceeds to S13 without doing anything. However, if it is determined that the predetermined period of time has elapsed (S11: YES), demo effects are performed on the upper liquid crystal display 3 and the lower liquid crystal display 4 in S12, and then the program proceeds to S13.

Then, it is determined whether operations of the PLAY-1-LINE button 37, PLAY-5-LINES button 38, and PLAY-20-LINES button 38 have been made or not in S13. Here, if it is determined that the operations of the PLAY-1-LINE button 37 and so on have not been made (S13: NO), the program returns to S11 and repeats the processes mentioned above. On the other hand, if it is determined that the operations of the PLAY-1-LINE button 37 and so on have been made (S13: YES), this routine is completed even in the middle of the demo effect performance.

Here, the determination may be made based on not only these operation signals, but also other input signals in the determination process in S13.

Next, in the slot machine 1 of the present embodiment, the lottery process in S2 is explained in reference to FIG. 14. FIG. 14 is a flow chart of the lottery process program in the slot machine of the present embodiment.

In the lottery process, one random number value is obtained from the numeric range of 0 to 65535 by the random number sampling circuit 56 (S21).

Next, the winning combination as a prize winning combination is determined based on the random number value (S22) by referring to the probability table (refer to FIGS. 8A through 8C) corresponding to the number of pay lines and the selected mode identified by the mode identification flag. Here, the probability to win “LOBSTER×5” is the lowest in MODE B while the probability to win “LOBSTER×5” is the highest in MODE C. After the lottery to determine the winning combination is conducted, another lottery to determine the stationary display of symbols (the lottery to determine the code number) is performed so as to display the winning combination in a stationary manner. Then, the program returns to the aforementioned main process program and proceeds to the base game process in S3.

The CPU 50 works as selection means when the processes in FIG. 14 are executed.

Next, the base game process to be conducted in the S3 with the slot machine 1 according to the present embodiment is explained in reference to FIG. 15. FIG. 15 shows a flow chart of the base game process program in the slot machine according to the present embodiment.

In the base game process, various kinds of symbols are scrolled in the variable display parts 21 through 25 (S31) based on the switch signal accepted in the start acceptance process (S1), the switch signal having been outputted from any of the 1-LINE switch 60, the 3-LINES switch 61 and the 5-LINES switch 62. Then, scrolling of the symbols in the variable display areas 21 through 25 is stopped (S33). Further, it is determined whether the combination displayed in a stationary manner in the variable display parts 21 through 25 is the winning combination or not such that the payout number is determined by referring to the probability table (refer to FIGS. 9A through 9C) corresponding to the specific mode identified by the mode identification flag, if the thus-displayed combination is the winning combination, and the corresponding number of coins, credit, or the like to the thus-determined payout number are paid out (S34). Here, the CPU 50 works as determination means as well as payout number determination means. Then, the program returns to the aforementioned main process program after the payout process and proceeds to the determination process in S4.

In the present embodiment, if it is determined that the symbols displayed in a stationary manner in the variable display parts 21 through 25 include the winning combination, the payout number is determined according to the winning combination as explained above. However, the payout number may be determined according to the combination of symbols displayed in a stationary mode without determining whether the combination of symbols include the winning combination or not. When the coins are paid out in the aforementioned process, the hopper driving circuit 70, the hopper 71, the payout completion signal circuit 72 and the coin detector 73 work as payout means. On the other hand, the CPU 50 works as the payout means if the credit is paid out.

Subsequently, in the slot machine 1 of the present embodiment, the bonus game process in S5 is explained in reference to FIG. 16. FIG. 16 is a flow chart of the bonus game process program in the slot machine of the present embodiment.

In the bonus game process, the game number T of the bonus game is first set. The game number of the bonus games is selected from 10 to 25 by the lottery based on the random number sampled by the random number sampling circuit 56. The set game number T of the bonus games is stored in the RAM 52.

Subsequently, a random number value is obtained in S52 and the winning combination determination process in the bonus game is conducted in S53. The process is similar to the processes S21 through S22.

Further, in the winning combination determination process in S53, it is determined whether the trigger winning combination (the case that five “SARDINE” symbols (sardine) are displayed in a stationary manner in the variable display parts 21 through 25 at the same time irrespective the activated pay lines) to shift the program to the bonus game is won or not (S54). Then, if the trigger winning combination for the bonus game is won (S54: YES), the repetition number t of the bonus games is newly determined by a lottery and the thus-determined repetition number t is added to the current game number T of the bonus games (S55). Thus, if the bonus game is won in the bonus game, the rest number of the bonus games is increased. More specifically, suppose that the program proceeds to the bonus game with 20 cycles of the repetition number, for example, for the first time. If the bonus game with 17 cycles of the repetition is won in the twelfth bonus game, the rest repetition number of the bonus games becomes 25 (20−12+17=25) so that the player can play twenty five (25) bonus games. On the other hand, if the trigger winning combination for the bonus game is not won (S54: NO), the program proceeds to S56.

In a symbol variable process of S56, symbols are automatically scrolled in the variable display parts 21 through 25.

In a stop control process of S57, the symbols being scrolled in the variable display parts 21 through 25 are stopped.

In the payout process of S58, it is determined whether the combination displayed in a stationary manner in the variable display areas 21 through 25 includes the winning combination or not. And if it is determined that the displayed combination includes the winning combination, the payout number is determined by referring to the payout table (refer to FIGS. 9A through 9C) corresponding to the specific mode identified by the mode identification flag and the corresponding number of coins, credit or the like to the thus-determined payout number are paid out (S58).

In the bonus game, “SHARK” symbol (shark) is handled as “LOBSTER” symbol (lobster) when the winning combination is determined by referring to the probability table.

Subsequently, in S59, the CPU 50 reads out the game number T of the bonus game which is stored in the RAM 52 and subtracts “1” from the thus-read game number T. And the processed game number T is again stored in the RAM 52.

Next, in S60, the CPU 50 determines whether the game number T of the bonus game reaches the predetermined number in S51 or not. More specifically, the determination is made depending on whether the game number T stored in the RAM 52 becomes “0” or not. If the game number T is not “0”, that is, it is determined that the number of executing the bonus games does not reach the number determined in S51 (S60: NO), the program returns to S52 and repeats the aforementioned processes. On the other hand, if it is determined that the game number T is “0”, that is, it is determined that the number of executing the bonus games reaches the number determined in S51 (S60: YES), the bonus game process program is terminated.

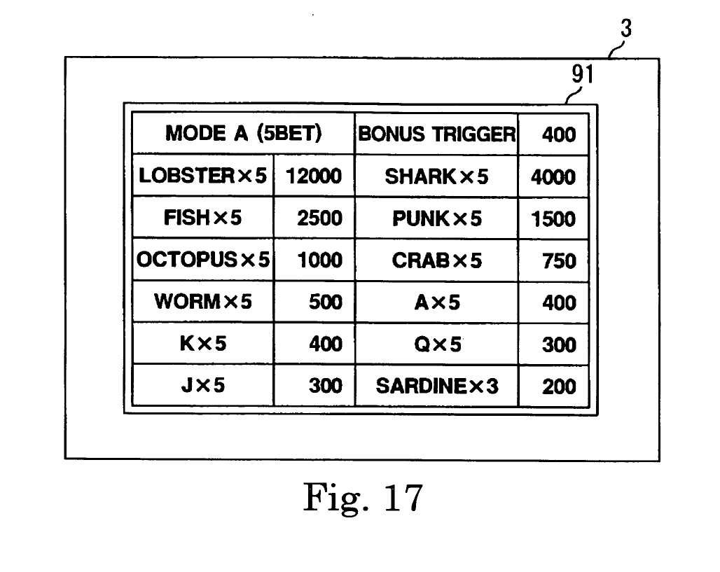

FIG. 17 is a front view showing an image displayed on an upper liquid crystal display when Mode A is selected.

A payout display image 91 is displayed in the upper liquid crystal display 3. The payout display image 91 includes an image indicating the game kind of “MODE A” and shows the relationship between each winning combination and each payout number of the coins to be paid out (refer to FIG. 9A).

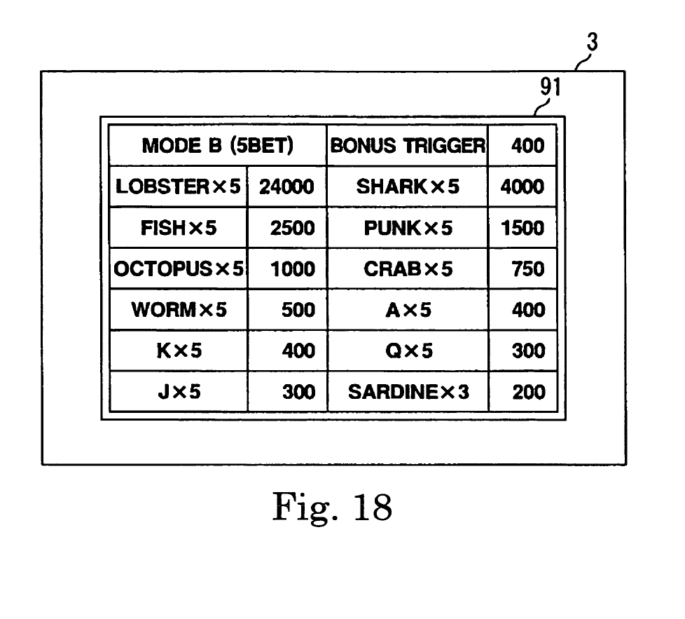

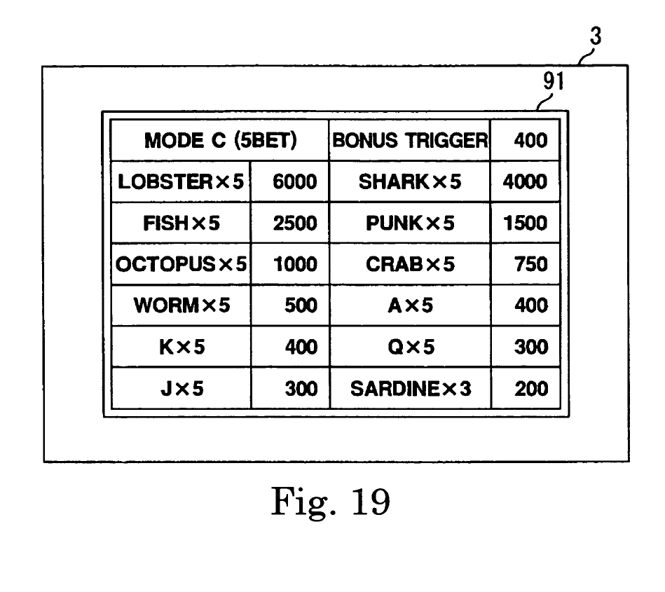

FIG. 18 is a front view showing an image displayed on an upper liquid crystal display when Mode B is selected.

A payout display image 91 is displayed in the upper liquid crystal display 3. The payout display image 91 includes an image indicating the game kind of “MODE B” and shows the relationship between each winning combination and each payout number of the coins to be paid out (refer to FIG. 9B). In the payout display image 91 of MODE B, the payout number of the coins for the winning combination “LOBSTER×5” is twice as many as that in the payout display image 91 in MODE A if compared.

FIG. 198 is a front view showing an image displayed on an upper liquid crystal display when Mode C is selected.

The payout display image 91 is displayed in the upper liquid crystal display 3. The payout display image 91 includes an image indicating the game kind of “MODE C” and shows the relationship between each winning combination and each payout number of the coins to be paid out (refer to FIG. 9C). In the payout display image 91 of MODE C, the payout number of the coins for the winning combination “LOBSTER×5” is one-half of that in the payout display image 91 in MODE A if compared.

As mentioned above, in the slot machine 1 according to the present embodiment, the expectation values of the payout number of coins for “LOBSTER×5” are the same and the variation (or variance) of the payout numbers differ in a plurality of kinds of MODE A through MODE C (refer to FIGS. 8A through 8C). The game proceeds in the selected MODE as the player conducts an operation to select one MODE out of MODE A through MODE C. Therefore, the player who wants to get many coins for a short period of time may select MODE B that provides rather large variation of the payout numbers set for the winning combination of “LOBSTER×5” so as to enhance the possibility to obtain many coins for a short period of time. On the other hand, the player who wants to enjoy the game for a long period of time may select the MODE that provides rather smaller variation of the payout numbers set for the winning combination of “LOBSTER×5” so as to keep the range of the number of coins having been earned small. Therefore, the player can select the MODE according to the player's own tastes such that his or her own demand and purpose toward the game can be satisfied while the amusement of the game is not deteriorated. And the expectation values of the winning combination of “LOBSTER×5” are the same for any one of MODE A through MODE C such that the expectation values of coins to be paid out in the game are the same so as to let the game arcade have a stable profit.

Also, in the slot machine 1, the history information about the mode selection in response to the player's operation (the number of games having been played in such a mode) is stored. And the mode having been selected most frequently by the player's operation among MODE A through MODE C is automatically selected at a predetermined timing (if the game has not been played longer than the predetermined period of time) such that the game proceeds in the thus-selected mode.

As mentioned above, since the mode that fits the player's tastes is apt to be selected automatically at the predetermined timing based on the history information, the player who wants to play the game quickly and the novice player who has little information of the game are not forced to make an operation to select the mode such that it is not likely to make these players recognize the game is too complicated and avoid the game because of this complexity. And the player who wants to get many coins for a short period of time and the player who wants to enjoy the game for a long period of time may only conduct an operation to select the desirable mode for the player's own tastes only if the automatically selected mode does not fit his or her own demand or purpose. Therefore, it is possible to adjust the game more desirably to various kinds of tastes and the demand and purpose toward the game.

Since the winning combination of “LOBSTER×5” is the winning combination which offers the highest payout number of coins and the player is most interested in, the player can easily selects the mode such that it is less likely to confuse the player. And since the winning combination of “LOBSTER×5” is a winning combination that offers relatively many coins, it is not needed to set a mode out of a plurality of kinds of modes for the winning combination that offers a relatively low number of coins to be paid out so as to avoid the complexity in designing the expectation values of the slot machine.

Also, when the predetermined payout number of the coins is changed for the winning combination of “LOBSTER×5” by selecting the mode, the thus-changed payout number of the coins is displayed on the upper liquid crystal display 3 such that the player can recognize the payout number of the coins for the winning combination of “LOBSTER×5” as the player plays the game.

In the present embodiment, although an explanation is made for the timing (or occasion) to select the game kind automatically when the game has not been played for a predetermined period, the present invention is not limited to this example, but the timing (or occasion) may include an occasion where the game has been played for a predetermined number, an occasion where the games are played for a predetermined period, an occasion where both of them are satisfied, and an occasion where the manager of the game arcade makes the prescribed setting and adjustment, for example.

In the present embodiment, although an explanation is made for the case provided with three game kinds, the number of game kinds is not limited in the present invention. Also, in the present embodiment, although an explanation is made for the case provided the specific winning combination of “LOBSTER×5”, the specific winning combination is not limited. Also, in the present embodiment, although an explanation is made for the case where probability tables and payout tables are provided to respective game kinds, for example, it is possible to apply the present invention to the case where the probability table and the payout table for one game kind are provided such that winning probabilities defined in such probability tables and payout numbers defined in such payout tables can be converted by a predetermined formula for the other game kinds. Also, in the present embodiment, although an explanation is made for the case where the expectation values for the specific winning combination in a plurality of game kinds is the same and the expectation values in the entire game are the same, the present invention is not limited to this example. But it is not necessary that the expectation values in the entire game should be the same as long as the expectation values in various modes are the same.

In the present embodiment, although an explanation is made for the case where the present invention is embodied in the slot machine, the present invention may be applied to other gaming machines (e.g., a pachi-slot machine).

In addition to the foregoing, the variation of the payout numbers may be defined as the difference between the highest and the lowest payout numbers for the specific winning combination among the different modes. Since the expectation number is kept constant, the probability to win the specific winning combination is decreased as the payout number is increased.

Further, the specific winning combination may have the highest expectation value among all the winning combinations so that the player may be most interested in the specific winning combination. By way of example, the expectation value for the specific winning combination may be more than twice as high as that for any one of the other winning combinations such that the specific winning combination dominant.

In the gaming industry, as mentioned above, the expectation value is extremely concerned. This is not only because it is regulated, but also because the expectation value affects very much on the management of the game center or the arcade. That is to say, if the expectation value becomes higher, more coins are paid out such that more pressure on the management may be provided while the arcade may be full of customers since it becomes more advantageous to the player so as to enhance the attractiveness to the game players. On the other hand, if the expectation value is low, the payout number of coins becomes low so that it appears that it becomes more favorable to the management of the game arcade. However, the players do not feel advantages such that the attractiveness may become less so as to give more pressure on the management of the game arcade. Thus, the expectation may affect very much on the management of the game arcade such that it is preferable to keep the expectation value constant so as to get a stable profit. However, if the expectation value is kept constant, the game contents will have a small range of the changes so as to cause a lower degree of the entertainment nature.

Here, the tastes of the player and the demand and the purpose of the player toward the game have various kinds. For example, some players want to obtain many coins for a short period of time and other players want to enjoy playing the game for a long period of time as the number of earned coins fluctuates within a small range. Some gaming machines can have a constant expectation value while variation of the number of paid out coins can become bigger, the fluctuation range of the number of earned coins ca be bigger as the variation of the number of paid out coins becomes bigger such that the demand and the purpose of the player who wants to enjoy playing the game for the long period of time may not be satisfied.

In addition to the above described embodiment, the following examples may also be included in the present invention.

In a gaming machine, a plurality of symbols is also displayed statically after being displayed variably and a corresponding number of game media to a predetermined winning combination are paid out if the statically-displayed plurality of symbols includes the winning combination. The gaming machine comprises: selection means for selecting one mode from a plurality of different modes having respectively different variations but substantially the same expectation value in the number of game media to be paid out for a specific winning combination in one game in response to an operation by a player; probability data storage means for storing probability data of winning probability determined for the predetermined winning combination in association with the selected mode; payout data storage means for storing predetermined payout data of the number of game media to be paid out for the predetermined winning combination in association with the selected mode; lottery means for conducting a lottery to determine the predetermined winning combination based on the probability data corresponding to the selected mode by the selection means; variable display means for conducting a variable display and a static display of the plurality of symbols at least based on a lottery result by the lottery means; determination means for determining whether a combination of the plurality of symbols being displayed statically matches a winning combination being determined by the lottery means; payout number determination means for determining the number of game media based on the payout data corresponding to the selected mode by the lottery means when the determination means determines that the combination of the plurality of symbols matches the winning combination determined by the lottery means; and payout means for paying out the determined number of game media by the payout number determination means.

In the above-described slot machine, the expectation values are the same for the specific winning combination (e.g., “LOBSTER×5”), but the variation of the payout numbers is different among a plurality of game kinds. One of the game kinds is selected in response to the player's operation and the game is played in the thus-selected game kind. Therefore, the player who wants to get many game media for a short period of time may be able to enhance the probability by selecting a game kind characterized by a large variation of the payout numbers for the specific winning combination. On the other hand, the player who wants to enjoy the game for a long period of time may select a game kind characterized by a small variation of the payout numbers for the specific winning combination such that the range of the number of coins having been earned may be small. Therefore, the player's demand and purpose toward the game may be satisfied without compromising the amusement of the game by selecting the game kind according to the player's own tastes. Also, even if any of the game kinds is selected, the expectation value for the entire game can be the same so as to keep the management of the game arcade stable since the expectation values for the specific winning combination are the same.

According to the present invention, the probability data may include data defining the winning probabilities for each winning combination such that the formality thereof is not limited. For example, a table summarizing the random number values to be used for the lottery in association with each winning combination can be referred to. Such a table may include a table (so-called look-up table) which listing a plurality of random numbers for the winning combination in a manner of many-to-one such that it is not limited to a table listing the random number for the winning combination in a manner of one-to-one. Also, it is not necessary that the probability data should be in the form of table, but the probability data may include data to be utilized or referred to when the calculation by the predetermined formula is made with the random number having been utilized in the lottery, for example.

In the present invention, the payout data may include data defining the payout number of game media for each winning combination, but is not limited in the formality of data. For example, a table can be employed. The payout data also may not be in a table form. For example, if the payout number of game media is calculated from the data indicating the winning combination, the data to be utilized or referred to may be included in the payout data according to the present invention.

The following is also provided. The aforementioned gaming machine further comprises: history information storage means for storing history information of mode selection by the determination means in responsive to the operation by the player. The selection means selects the one mode from the plurality of modes at a predetermined timing based on the history information stored in the history information storage means, the selected one mode having been selected most frequently or for a longest period of time in responsive to the operation by the player.

According to the above-mentioned gaming machine, the history information (such as the number of selection of the game kind, the number of the games of thus-selected game kind to be played, and a period of time when the game of thus-selected game kind has been played) about the game kind selection in response to the player's operation is stored. Then, at a predetermined timing (such as every time when the predetermined period of time elapses, and when the predetermined number of games have been played, when the manager of the game arcade makes settings or adjustment), one game kind that has been played most frequently or for the longest period of time in response to the player's operation may be selected from a plurality of game kinds and the game of the thus-selected game kind is played.

Thus, since the game kind is automatically selected based on the history information so as to fit the player's tastes, the player who wants to play the game quickly and the novice player who has little information about the game are not forced to conduct an operation to select the game kind and do not recognize the game contents are too complicated such that the game contents may not be too complicated.

Also, the player who wants to get many game media for a short period of time and the player who wants to play the game for a long time only have to make an operation to select the game kind to fit the player's tastes only if the automatically-selected game kind does not suit for the player's demand and purpose. Therefore, it is possible to adjust the game to the player's various tastes and the player's demand and purpose more appropriately.

Further, the following is also provided. In the above-described gaming machine, an average payout number of game media for the winning combination among payout numbers of game media for the winning combination in the plurality of modes is more than any other payout numbers of game media for any other winning combination in the plurality of modes.

According to the above-mentioned gaming machine, since the specific winning combination is a winning combination that offers relatively many game media to be paid out and is of high interest for the player, the player can easily to select the game kind for the player's own tastes and may not be puzzled in choosing the game kind. Also, since the specific winning combination is a winning combination that offers relatively many game media to be paid out, it is not necessary to set a game kind out of the plurality of kinds of game kinds for the other winning combination that offers relatively few game media to be paid out so as to avoid the complexity in design of the expectation values in the gaming machine. These effects are more important for the game having more kinds of winning combinations.

Also, the above-described gaming machine further comprises: payout display means for displaying a predetermined number of game media for each winning combination. The payout display means displays the payout number corresponding to the mode when the mode is selected.

According to the above-mentioned gaming machine, since the payout display means displays, when the predetermined payout number for the specific winning combination is changed by selecting the game kind, the changed payout number, the player can recognizes the payout numbers of game media determined for the specific winning combination as the player plays the game.

According to the present invention, it is possible to make the profit of the game arcade stable and to satisfy the player's various kinds of tastes.

In the foregoing, an explanation is made for the embodiment according to the present invention, only a concrete example is made and the present invention is not limited to such examples, but concrete configuration such as each means can be modified. Also, the above-described effects are most preferable effects caused by the present invention and the effects of the present invention are not limited to those described in the present embodiment of the present invention.

What is claimed is:

1. A gaming machine comprising: a display device for conducting a stationary display and a variable display of a plurality of symbols, in which a predetermined amount of game value is provided when a combination of the plurality of symbols being displayed in a stationary manner after being displayed variably matches a winning combination in one game,
wherein a plurality of modes having different natures of the one game, one of which can be selected by a player, is provided; and
wherein each of the plurality of modes differentiates both probability to win a specific winning combination and an amount of game value associated with the specific winning combination, and an expectation value of the amount of game value to be provided to the player is kept substantially identical for each of the plurality of modes in the one game.

2. The gaming machine according to claim 1, wherein the expectation value is calculated based on the probability to win the specific winning combination and the amount of the game value associated with the specific winning combination for each of the plurality of modes.

3. The gaming machine according to claim 1, wherein the predetermined amount of game value is provided based on a mode the player has selected from the plurality of modes in a case of the specific winning combination as a result of the one game.

4. The gaming machine according to claim 1, wherein a mode having been used most frequently is automatically selected if the operation by the player is not conducted within a predetermined period of time.

5. The gaming machine according to claim 1, wherein the display device displays the mode having been selected and the amount of game value to be provided for the winning combination in the selected mode.

6. The gaming machine according to claim 1,
wherein an average value of amounts of game value to be provided for the specific winning combination over the plurality of modes is larger than an average value of amounts of game value to be provided for a winning combination other than the specific winning combination over the plurality of modes.

7. The gaming machine according to claim 1,
wherein the amount of game value to be provided for the specific winning combination is larger than an amount of game value to be provided for a winning combination other than the specific winning combination.

8. A gaming machine, in which a plurality of symbols is displayed statically after being displayed variably and a corresponding number of game media to a predetermined winning combination are paid out if the statically-displayed plurality of symbols includes the winning combination, the gaming machine comprising:
selection means for selecting one mode from a plurality of different modes having respectively different variations but a substantially same expectation value in the number of game media to be paid out for the predetermined winning combination in one game in response to an operation by a player;
probability data storage means for storing probability data of winning probability determined for the predetermined winning combination in association with the selected mode;
payout data storage means for storing predetermined payout data of the number of game media to be paid out for the predetermined winning combination in association with the selected mode;
lottery means for conducting a lottery to determine the predetermined winning combination based on the probability data corresponding to the selected mode by the selection means;
variable display means for conducting a variable display and a static display of the plurality of symbols at least based on a lottery result by the lottery means;
determination means for determining whether a combination of the plurality of symbols being displayed statically matches a winning combination being determined by the lottery means;
payout number determination means for determining the number of game media based on the payout data corresponding to the selected mode by the lottery means when the determination means determines that the combination of the plurality of symbols matches the winning combination determined by the lottery means; and
payout means for paying out the determined number of game media by the payout number determination means.

9. The gaming machine according to claim 8, further comprising:
history information storage means for storing history information of mode selection by the determination means in responsive to the operation by the player,
wherein selection means selects the one mode from the plurality of modes at a predetermined timing based on the history information stored in the history information storage means, the selected one mode having been selected most frequently or for a longest period of time in responsive to the operation by the player.

10. The gaming machine according to claim 8, wherein an average payout number of game media for the winning combination among payout numbers of game media for the winning combination in the plurality of modes is more than any other payout numbers of game media for any other winning combination in the plurality of modes.

11. The gaming machine according to claim 8, further comprising:
payout display means for displaying a predetermined number of game media for each winning combination, the payout display means displaying the payout number corresponding to the mode when the mode is selected.

12. A gaming machine comprising: a display device for conducting a stationary display and a variable display of a plurality of symbols, in which a number of game media are paid out when a combination of the plurality of symbols being displayed in a stationary manner after being displayed variably includes a winning combination in a game,
wherein the game comprises a plurality of modes to be selected;
wherein an expectation value given by a product of a probability to win a first winning combination and a predetermined payout number of game media to be paid out for the first winning combination is substantially same in each of the plurality of modes, but payout numbers for the first winning combination differ in the plurality of modes, respectively;
wherein a mode is selected from the plurality of modes in response to an operation by a player; and
wherein a predetermined number of game media are paid out when the first winning combination is won in the selected mode in the game; and
wherein a mode having been used most frequently is automatically selected if the operation by the player is not conducted within a predetermined period of time.
